(19) United States
(12) Patent Application Publication
(10) Pub. No.: US 2023/0376122 A1
(43) Pub. Date: Nov. 23, 2023

(54) INTERFACE DISPLAYING METHOD, APPARATUS, DEVICE AND MEDIUM

(71) Applicant: Beijing Zitiao Network Technology Co., Ltd., Beijing (CN)

(72) Inventor: Chin-Wei LIU, Beijing (CN)

(21) Appl. No.: 18/319,955

(22) Filed: May 18, 2023

(30) Foreign Application Priority Data
May 23, 2022 (CN) 202210562059.4

(51) Int. Cl. G06F 3/01; G06T 3/40; G06T 11/00

(52) U.S. Cl. CPC G06F 3/017; G06T 3/40; G06T 11/001; G06T 2210/12; G06T 2200/24

(57) ABSTRACT

The present disclosed embodiment relates to an interface displaying method, apparatus, device, and medium. The method comprises: in response to an interface displaying instruction, recognizing a preset human body part; determining an interface displaying area on the recognized preset human body part; and generating and displaying an operation interface according to the interface displaying area. In embodiments of the present disclosure, the operation interface is displayed on a determined interface displaying area on a human body part, ensuring the user's sense of clicking, improving the user's operating experience, and further enhancing the intelligence degree of the operation interface.

### CROSS REFERENCE TO RELATED APPLICATIONS

The present application claims priority to Chinese Patent Application No. 202210562059.4, entitled “INTERFACE DISPLAYING METHOD, APPARATUS, DEVICE AND MEDIUM,” filed on May 23, 2022, the contents of which are hereby incorporated by reference in its entirety.

### TECHNICAL FIELD

The present disclosure relates to the field of computer application technology, and in particular to an interface displaying method, apparatus, device, and medium.

### BACKGROUND

With the development of computer technology, in order to enhance intelligent experience of operation, the ways for operation interfaces are becoming increasingly diverse.

In related solutions, in order to improve an intelligence degree of an interface operation, a non-contact operation is carried out on an operation interface by means of a non-contact gesture trajectory, and an interactive operation is performed on a relevant operation interface by recognizing position information of a user's hand joint.

However, the above non-contact operation on the operation interface by means of a non-contact gesture trajectory allows users to perform gesture operations in the air, which leads to poor sense of clicking when users are performing clicking operations. Thus, such operations are not real enough to the users.

### SUMMARY

In order to solve or at least partially solve the above technical problem, the present disclosure provides an interface displaying method, apparatus, device, and medium for displaying an operation interface on an interface displaying area determined on a human body part, which ensures the user's sense of clicking, improves the user's operating experience, and further enhances the intelligence degree of the operation interface.

An embodiment of the present disclosure provides an interface displaying method, which comprises: in response to an interface displaying instruction, recognizing a preset human body part; determining an interface displaying area on the recognized preset human body part; and generating and displaying an operation interface according to the interface displaying area.

An embodiment of the present disclosure also provides an interface displaying apparatus, which comprises: a recognizing module configured to in response to an interface displaying instruction, recognize preset human body part; a determining module configured to determine an interface displaying area on the recognized preset human body part; a displaying module configured to generate and display the operation interface according to the interface displaying area.

An embodiment of the present disclosure also provides an electronic device, which comprises: a processor; and a memory for storing executable instructions for the processor. The processor is configured to read the executable instructions from the memory and execute the executable instructions to implement the interface displaying method provided by the embodiments of the present disclosure.

An embodiment of the present disclosure also provides a computer readable storage medium storing a computer program. The computer program is configured to perform the interface displaying method of the embodiments of the present disclosure.

Compared with the prior art, the technical solution provided by embodiments of the present disclosure has the following advantages.

In the interface displaying solution of the present disclosed embodiment, in response to the interface displaying instruction, the preset human body part is recognized. Furthermore, if the preset human body part is recognized, the interface displaying area on the recognized preset human body is determined. Moreover, the operation interface is generated and displayed according to the interface displaying area. As a result, by displaying the operation interface on the determined interface displaying area of the human body part, a sense of clicking is ensured for user's operation, the operating experience of the user is improved, and the intelligence level of the operation interface is further enhanced.

### BRIEF DESCRIPTION OF DRAWINGS

The above and other features, advantages, and aspects of each embodiment of the present disclosure will become more apparent in combination with the accompanying drawings and with reference to the following specific implementation methods. Throughout the drawings, identical or similar reference numerals represent identical or similar elements. It should be understood that the drawings are illustrative, and the components and elements may not necessarily be drawn to scale.

FIG. 1 shows a schematic flowchart of an interface displaying method provided for an embodiment of the present disclosure;

FIG. 2 shows a schematic diagram of an interface displaying scenario provided for an embodiment of the present disclosure;

FIG. 3 shows a schematic diagram of another interface displaying scenario provided for an embodiment of the present disclosure;

FIG. 4 shows a schematic flowchart of another interface displaying method provided for an embodiment of the present disclosure;

FIG. 5 shows a schematic diagram of another interface displaying scenario provided for an embodiment of the present disclosure;

FIG. 6 shows a schematic diagram of another interface displaying scenario provided for an embodiment of the present disclosure;

FIG. 7 (a) shows a schematic diagram of another interface displaying scenario provided for an embodiment of the present disclosure;

FIG. 7 (b) shows a schematic diagram of another interface displaying scenario provided for an embodiment of the present disclosure;

FIG. 7 (c) shows a schematic diagram of another interface displaying scenario provided for an embodiment of the present disclosure;

FIG. 8 shows a schematic diagram of another interface displaying scenario provided for an embodiment of the present disclosure;

FIG. 9 shows a schematic diagram of another interface displaying scenario provided for an embodiment of the present disclosure;

FIG. 10 shows a schematic diagram of a structure of an interface displaying apparatus provided for an embodiment of the present disclosure; and

FIG. 11 shows a schematic diagram of a structure of an electronic device provided for an embodiment of the present disclosure.

### DETAILED DESCRIPTIONS

The embodiments of the present disclosure will be described in more detail below with reference to the accompanying drawings. Although some embodiments of the present disclosure are shown in the drawings, it should be understood that the present disclosure can be implemented in various forms and should not be interpreted as limited to the embodiments described herein. On the contrary, these embodiments are provided for a more thorough and complete understanding of the present disclosure. It should be understood that the accompanying drawings and embodiments of the present disclosure are only for illustrative purposes and are not intended to limit the scope of protection of this disclosure.

It should be understood that various steps recorded in the disclosed method implementation may be executed in different orders and/or in parallel. In addition, the method implementation may include additional steps and/or omit the steps shown for execution. The scope of this disclosure is not limited in this regard.

The term “including” and its variations used herein are open inclusion, that is, “including but not limited to”. The term “based on” refers to “at least partially based on”. The term “one embodiment” means “at least one embodiment”; The term “another embodiment” means “at least one other embodiment”; The term “some embodiments” means “at least some embodiments”. The relevant definitions of other terms will be given in the following description.

It should be noted that the concepts such as “first” and “second” mentioned in this disclosure are only used to distinguish different apparatus, modules or units, and are not intended to limit the order or interdependence of the functions performed by these apparatus, modules or units.

It should be noted that the modifications of “one” and “multiple” mentioned in this disclosure are indicative rather than restrictive, and those skilled in the art should understand that unless otherwise explicitly stated in the context, they should be understood as “one or more”.

The names of the messages or information exchanged between apparatuses in embodiments of the present disclosure are for illustrative purposes only and are not intended to limit the scope of these messages or information.

As mentioned above, the above non-contact gesture trajectory-based approach for the non-contact operation on the operation interface allows users to perform gesture operations in the air. Compared to operations on a physical interface, there is a lack of a sense of clicking when clicking, which affects the user's interaction experience.

To address the aforementioned technical issues, embodiments of the present disclosure provide an interface displaying method, which will be introduced in conjunction with specific embodiments below.

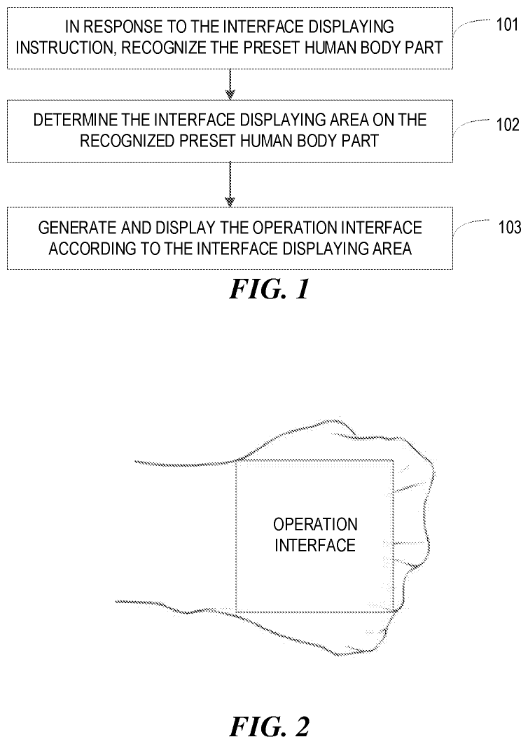

FIG. 1 shows a flowchart of an interface displaying method provided in an embodiment of the present disclosure, which may be performed by an interface displaying apparatus. The apparatus may be implemented using a software and/or a hardware and can generally be integrated into an electronic device. As shown in FIG. 1, this method includes the following steps.

At step 101, in response to the interface displaying instruction, the preset human body part is recognized.

The preset human body part includes but are not limited to any limb part such as a hand and an arm.

In some possible embodiments, the interface displaying instruction may be implemented based on a gesture operation of the user.

In this embodiment, a current gesture action of the user is detected. For example, an image of the user's hand may be captured and input into a pre-trained deep learning model. According to the output of the deep learning model, the current gesture action is determined. In this embodiment, if the current gesture action is determined to be a preset gesture action, then the interface displaying instruction is obtained. Therefore, the implementation of triggering the interface displaying instruction based on the user gesture action improves the interaction experience.

In further possible embodiments, an interface displaying instruction may be detected, for example, by recognizing a voice instruction of a user, or determining whether a user triggers a predefined control or in other suitable ways, which are not detailed here.

After obtaining the interface displaying instruction, the preset human body part is recognized in response to the interface displaying instruction. For example, images may be captured by a camera, such that the preset human body part may be recognized based on the captured image. In this embodiment, the captured image may be input into the pre-trained deep learning model, and the preset human body part may be recognized based on the deep learning model.

At step 102, the interface displaying area is determined on the recognized preset human body part.

In this embodiment, if the preset human body part is recognized, the interface displaying area is determined on the preset human body part, in order to ensure the operating experience of the user. As the interface displaying area is located on the preset human body part, the determination of the interface displaying area is limited to the preset human body part. Thus, the operation interface is avoided to be displayed in the air, which otherwise would result in poor operating experience.

At step 103, the operation interface is generated and displayed according to the interface displaying area.

In this embodiment, when determining the interface displaying area, an operation interface is generated and displayed according to the interface displaying area. The operation interface typically includes commonly used controls, which typically include functional controls such as “exit”, “previous”, “next”, “shutdown”, and may also include shortcut function controls set by the user according to personal needs.

It should be noted that since the interface displaying area is on the preset human body part, the user may click on the preset human body part such that a sense of click is obtained when performing an interface interacting operation, which improves the operating experience of the user. As shown in FIG. 2, if the preset human body part is a hand, the interface displaying method of this embodiment may display the operation interface on the interface displaying area of the hand, thereby ensuring the operating experience of the user.

In summary, the interface displaying method of the present disclosed embodiment, in response to the interface displaying instruction, the preset human body part is recognized. Furthermore, if the preset human body part is recognized, the interface displaying area on the recognized preset human body is determined. Moreover, the operation interface is generated and displayed according to the interface displaying area. As a result, on the determined interface displaying area of the human body part, the operation interface is displayed, ensuring a sense of clicking for user's operation, improving the operating experience of the user, and further enhancing the intelligence level of the operation interface.

It should be noted that the above interface displaying area is located on the preset human body part, which can ensure the user's clicking experience. Therefore, in different application scenarios, on the premise of ensuring the interface displaying area to be located on the preset human body part, there are different ways for determining the interface displaying area on the preset human body part, as discussed in the following examples.

In an embodiment of the present disclosure, the area where the preset human body part is located is directly determined to be the interface displaying area. In this way, the operation interface displayed in the interface displaying area is ensured to be located on the preset human body part, which ensures the user's operating experience.

In this embodiment, area size information of the interface displaying area is recognized. The area size information includes but is not limited to one or more of the information used to identify the size of the interface displaying area, such as area information of the interface displaying area, a number of pixels contained in the interface displaying area, and length information of a contour line in the interface displaying area. In different application scenarios, the ways to recognize the area size information of the interface displaying area are different, as discussed below.

In an embodiment of the present disclosure, the number of edge pixels is recognized in the interface displaying area, and the size information is determined according to the number of edge pixels.

For example, when the interface displaying area is a rectangular area, a number of pixels contained on each side of the rectangular area is recognized. A length of each side is determined according to the number of pixels, and the length is used as the area size information.

In this embodiment, in order to ensure that the operation interface is limited to the interface displaying area on the human body part, the area size information of the interface displaying area is recognized, and the operation interface is generated and displayed according to interface area size information. Therefore, the size of the operation interface matches the size information of the interface area.

Furthermore, the operation interface is generated and displayed according to the area size information.

It should be noted that in different application scenarios, there may be different ways for generating and displaying the operation interface according to the area size information, as discussed below.

In some possible examples, during generating and displaying the operation interface according to the area size information, scaling ratio information may be determined according to the area size information. For example, standard area size information is preset, and the scaling ratio information is obtained by calculating the ratio between the area size information and the standard area size information.

Furthermore, a preset standard operation interface is scaled according to the scaling ratio information to generate and display the operation interface. The preset standard operation interface is a pre-set operation interface generated according to a standard size. In this example, the preset standard operation interface is scaled based on the scaling ratio information to generate and display the operation interface that adapts to the area size information. On the one hand, it ensures that the operation interface is displayed on the preset human body part, the user's clicking experience during operations is ensured. On the other hand, it makes the operation interface displayed on the preset human body part is large enough to ensure that the user can clearly and intuitively obtain information about relevant control(s) on the operation interface.

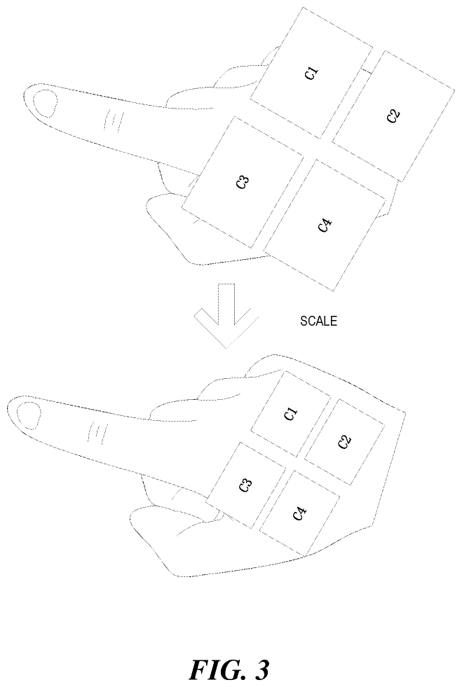

In further embodiments, after the scaling ratio information is determined according to the area size information, the preset operating control is scaled according to the scaling ratio information. The operation interface includes some preset operating controls, for example, as shown in FIG. 3, the operation interface consists of four operating controls C1-C4. Therefore, the preset operating controls can be scaled according to the scale ratio information, and the preset operating control can be understood as the operating control set according to the standard area size information. If the operating control set by the standard size information is directly displayed, it may cause some operation interfaces to be in the air, and affect the user's clicking experience.

Furthermore, the operation interface is generated according to the scaled preset operating control. In this embodiment, the scaled preset operating control is adapted to the size of the interface displaying area. Therefore, still referring to FIG. 3, the operation interface generated according to the scaled preset operating control is adapted to the interface displaying area, which improves the user's clicking experience.

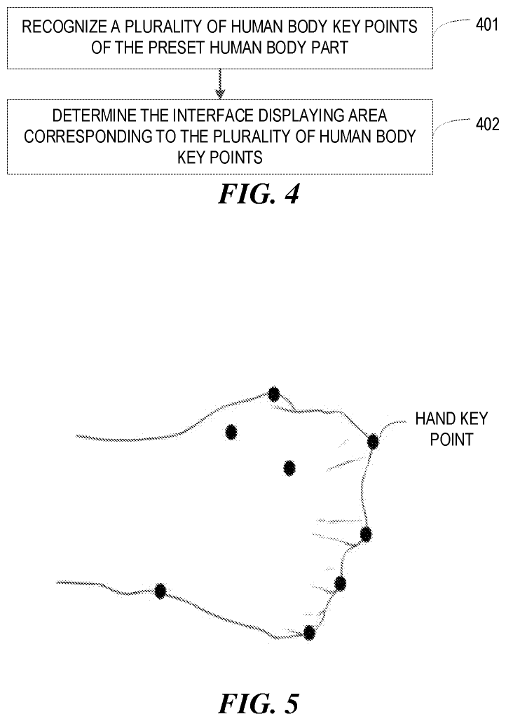

In an embodiment of the present disclosure, as shown in FIG. 4, determining the interface displaying area on the recognized preset human body part includes recognizing, at step 401, multiple human body key points of the preset human body part.

The human body key points can be understood as bone key points on the preset human body part. For example, as shown in FIG. 5, if the preset human body part is the hand, the human body key points are positions of the hand joint points. The human body key points may be recognized by analyzing a preset human body part image through a pre-trained convolutional neural network model.

At step 402, the interface displaying area corresponding to the plurality of human body key points is determined.

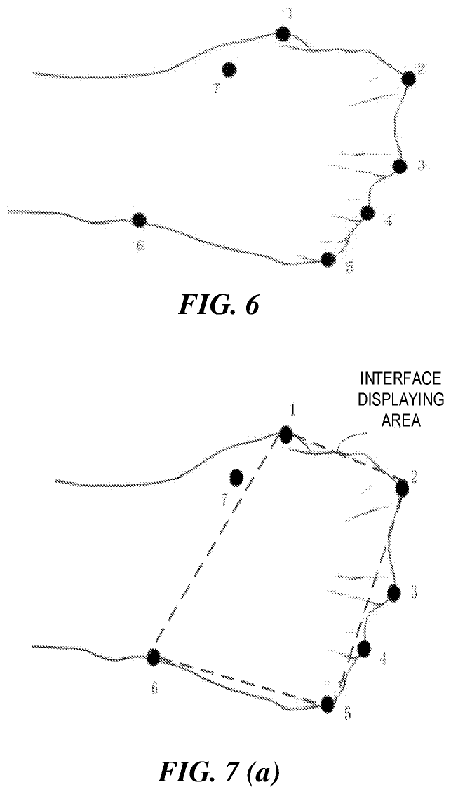

In this embodiment, edge human body key points may be determined from a plurality of human body key points. In other words, the edge human body key points are determined from the plurality of human body key points in order to maximize the displaying range on the preset human body part. For example, as shown in FIG. 6, in the case that the preset human body part is the hand, the recognized hand key points are 1-7, and the interface displaying area corresponding to the plurality of human body key points is determined.

In some possible embodiments, the area surrounded by the reference bounding box may be directly determined to be the interface displaying area.

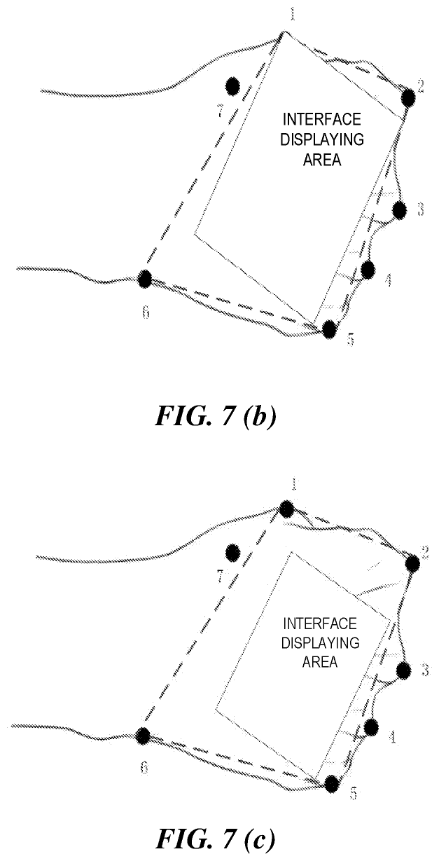

In this embodiment, as shown in FIG. 7 (a), if the preset human body part is the hand and the edge human body key points are 1, 2, 5, and 6, points 1, 2, 5, and 6 may be connected to obtain the reference bounding box. Then the reference bounding box is determined to be the interface displaying area.

In further possible embodiments, in the reference bounding box and according to a preset shape, an area surrounded by a maximum bounding box may be determined to be the interface displaying area. The preset shape includes but are not limited to a rectangle, a triangle, a circle, etc. The specific preset shape may be set according to different scenarios, which do not suggest any limitations here.

In this embodiment, as shown in FIG. 7 (b), if the preset human body part is the hand, and the edge human body key points are 1-4, then points 1-4 may be connected to obtain the reference bounding box. If the preset shape is a rectangle, the maximum bounding box of the rectangle is determined to be the interface displaying area in the reference bounding box.

In other possible embodiments, in the reference bounding box, an area with a preset shape and a preset size is determined to be the interface displaying area. The preset shape may include but is not limited to a rectangle, a triangle, a circle, etc. The specific preset shape may be set according to the scene without limitation. The preset size may be any size to ensure that the interface displaying area is located at the reference bounding box. The preset size may be determined according to the size of the reference bounding box, for example, the size information of the reference bounding box is determined, and at least one candidate preset sizes are determined according to the size information of the reference bounding box. The interface displaying area corresponding to each candidate preset size is smaller than the size of the reference bounding box, and any one of at least one candidate preset sizes may be determined to be the preset size of the interface displaying area.

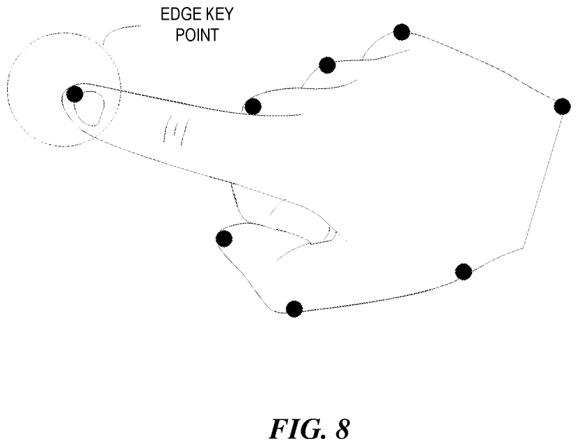

In this embodiment, as shown in FIG. 7 (c), if the preset human body part is the hand, and the edge human body key points are 1-4, then points 1-4 may be connected to obtain the reference bounding box. If the preset shape is a rectangular, then a rectangular area is determined in the reference bounding box according to the preset size to be the interface displaying area, where the rectangular area is located within the reference bounding box. In order to ensure that the reference bounding box determined based on edge key points does not include a suspended area, the human body key points that do not include a suspended area is firstly filtered out before determining the edge pixels, and then the operation in the above embodiment is performed on the filtered human body key points. For example, if the human body part is preset as the hand, but the hand posture is shown in FIG. 8, in order to avoid the interface displaying area determined according to the edge pixels between the fingers from containing a suspended area, the hand pixels is deleted before determining the edge pixels.

Furthermore, after determining the interface displaying area, the operation interface adapted to the interface displaying area is generated according to the area size information. For example, after determining the interface displaying area corresponding to multiple human body key points, the area size information of the interface displaying area may be recognized, and the scaling ratio information may be determined according to the area size information. In the embodiments of the present disclosure, the operation interface may be generated in real-time according to the area size information, that is, the scaling ratio information is determined according to the region size information. For example, the standard region size information is set in advance, the scaling ratio information is obtained by calculating the ratio of the area size information to the standard area size information.

Furthermore, a preset operating control may be scaled according to the scaling ratio information. The preset operating control may be understood as the operating control that set an initial size according to the standard area size information. If the operation interface is directly displayed according to the initial size, it may cause some operation interfaces to be in the air, affecting the user's clicking experience.

In the actual implementing process, in order to improve the viewing experience, in one embodiment of the present disclosure, rendering color information corresponding to the operation interface is also determined, and then the operation interface is rendered according to the rendering color information.

In some possible embodiments, the rendering color information corresponding to the operation interface may be default or customized by the user according to personal preferences. In other possible embodiments, current environment information of a displaying device may be recognized, and the rendering color information may be determined according to the environment information. The current environment information includes but is not limited to one or more of geographic location information, customs information, climate information, etc. Furthermore, a color information database corresponding to the current environment information is determined, and the color information database contains color information that adapts to the current environment information. For example, if the current environment information contains customs information, then the corresponding color information database contains color information that matches the current customs and is highly accepted by users. Therefore, the rendering color information obtained from the color information database will be more popular among users.

In other possible embodiments, considering that if an interface color of the operation interface displayed is closer to a skin color of the human body part, the user's viewing experience may be affected, thereby the operation is affected. Therefore, in order to facilitate the user to see the operation interface clearly, a specific skin color situation presented by the environment on the preset human body part is also adapted, and the color of the operation interface is rendered according to the skin color.

In this embodiment, the reference color information of the interface displaying area is obtained, which represents the specific skin color. For example, a pixel mean of all pixels in the interface displaying area is recognized as the reference color information. For example, all pixels in the interface displaying area may be clustered according to pixel values, and the number of pixels in each class obtained from clustering is counted. The pixel mean of all pixels with the highest number of pre-set digits is determined, and the pixel mean is used as the reference color information to avoid the influence of some noise pixels.

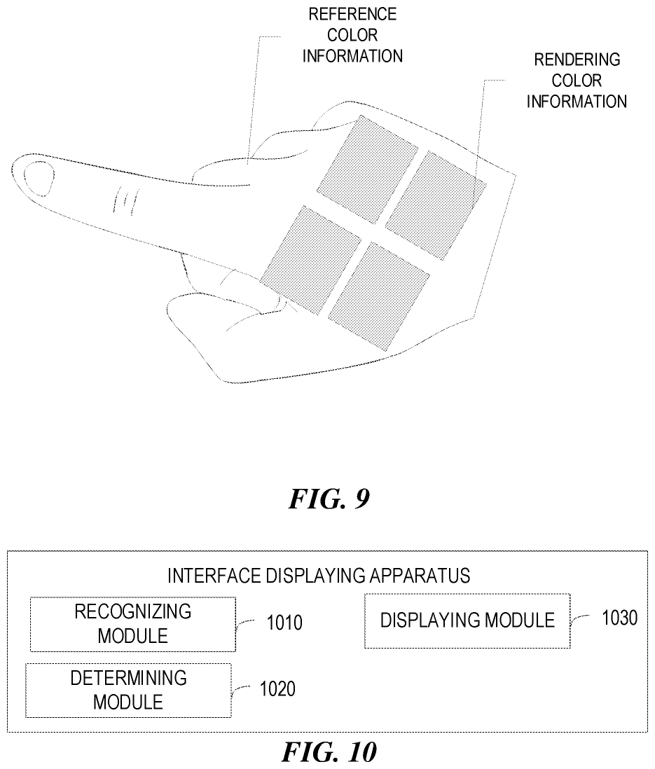

After determining the reference color information, the rendering color information is determined according to the reference color information. As shown in FIG. 9, there is a significant visual difference between the rendering color information and the reference color information, thereby ensuring that the user can clearly view the operation interface and providing convenience for the user's operations.

The rendering color information determined according to the reference color information may be one or more. In some possible embodiments, a preset database may be queried to obtain the rendering color information corresponding to the reference color information. In other possible embodiments, the reference color information may also be summed with a preset pixel difference threshold to determine the rendering color information according to the sum result. If the rendering color information is multiple, the preset pixel difference threshold is multiple.

In order to further ensure that the rendering color information of the operation interface is loved or accepted by the user, and the user experience is improve, the rendering color information may also be determined in combination with the above method of determining the rendering color information according to a current geographic environment information of the displaying device, to avoid conflicts between the rendering color information and local environment information, for example to ensure that the rendering color information matches local customs and preferences.

In an embodiment of the present disclosure, the current geographical environment information of the displaying device is recognized, which includes geographical location information, cultural environment information, etc. Thereby, black list color information and white list color information corresponding to the current geographical environment information is obtained by querying the preset database, etc. The blacklist color information may include color information that conflicts with the customs of the current geographical environment information, while the white list color information may include the color information that matches the customs of the current geographical environment information.

Furthermore, before rendering the operation interface according to the rendering color information, whether the rendering color information determined in the above embodiment contains target rendering color information that belongs to the black list color information is judged. If the rendering color information contains the target rendering color information that belongs to the black list color information, the target rendering color information is changed according to the white list color information. For example, a white list color is randomly selected from the white list color information that is close to the pixel value of the target rendering color information to change the target rendering color information, etc.

In summary, the interface displaying method of this disclosed embodiment flexibly determines the interface displaying area according to the needs of the scene, and further generates the operation interface according to the area size information of the interface displaying area, ensuring that the generated operation interface is located on the human body area, ensuring the user's sense of clicking and improving the operating experience of the user.

In order to implement the above embodiments, the present disclosure also proposes an interface displaying apparatus.

FIG. 10 is a schematic diagram of the structure of the interface displaying apparatus provided in the present disclosed embodiment, which can be implemented by a software and/or a hardware and can generally be integrated into an electronic device for interface displaying. As shown in FIG. 10, the apparatus includes: a recognizing module 1010, a determining module 1020, and a displaying module 1030.

The recognizing module 1010 is configured to recognize the preset human body part in response to the interface display instruction.

The determining module 1020 is configured to determine the interface displaying area on the recognized preset human body part.

The displaying module 1030 is configured to generate and display the operation interface according to the interface displaying area.

The interface displaying apparatus provided in the disclosed embodiment may perform the interface displaying method provided in any of the disclosed embodiments, and has the corresponding functional modules and beneficial effects of the method. It will not be repeated herein.

In order to implement the above embodiments, the present disclosure also proposes a computer program product, including a computer program/instruction, which implements the interface displaying method in the above embodiment when executed by the processor.

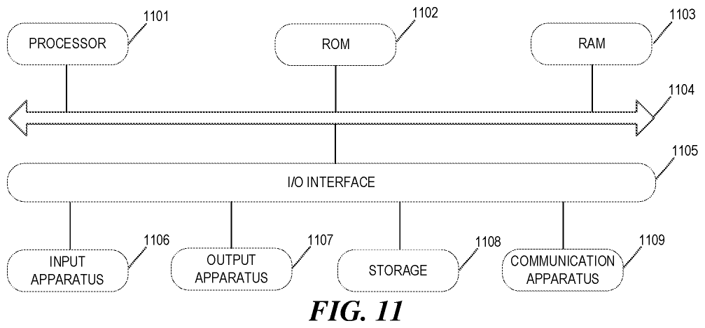

FIG. 11 is a schematic diagram of the structure of an electronic device provided in an embodiment of the present disclosure.

Reference is specifically made to FIG. 11, which is a schematic structural diagram illustrating an electronic device 1100 suitable for implementing the embodiments of the present disclosure. The electronic device 1100 in the embodiments of the present disclosure may include but is not limited to a mobile terminal such as a mobile phone, a notebook computer, a digital broadcast receiver, a PDA (personal digital assistant), a PAD (tablet), a PMP (portable multimedia player), and an in-vehicle terminal (e.g., in-vehicle navigation terminal) as well as a stationary terminal such as a digital TV and a desktop computer. The electronic device shown in FIG. 11 is only an example, and should not impose any limitation on the function and scope of use of the embodiments of the present disclosure.

As shown in FIG. 11, the electronic device 1100 may include a processor (e.g., a central processing unit, or a graphics processing unit) 1101. The processor 1101 may perform various appropriate actions and processing according to a program stored in a read only memory (ROM) 1102 or a program loaded from a storage 1108 into a random-access memory (RAM) 1103. In the RAM 1103, various programs and data necessary for the operation of the electronic device 1100 are also stored. The processor 1101, the ROM 1102, and the RAM 1103 are connected to each other via a bus 1104. An input/output (I/O) interface 1105 is also connected to the bus 1104.

Generally, the following apparatuses may be connected to the I/O interface 1105: an input apparatus 1106 including, for example, a touch screen, a touch pad, a keyboard, a mouse, a camera, a microphone, an accelerometer and a gyroscope; an output apparatus 1107 including, for example, a liquid crystal display (LCD), a speaker and a vibrator; a storage 1108 including, for example, a tape and a hard disk; and a communication apparatus 1109. The communication apparatus 1109 may allow the electronic device 1100 to communicate wirelessly or by wire with other devices so as to exchange data. Although FIG. 11 shows the electronic device 1100 having various apparatuses, it should be understood that the electronic device 1100 is unnecessary to implement or have all of the illustrated apparatuses. Alternatively, the electronic device 1100 may implement or be equipped with more or fewer apparatuses.

Particularly, according to embodiments of the present disclosure, the processes described above with reference to the flowcharts may be implemented as computer software programs. For example, a computer program product is provided according to embodiments according to the present disclosure. The computer program product includes a computer program carried on a computer readable medium. The computer program contains program code for carrying out the method shown in the flowchart. In such embodiments, the computer program may be downloaded and installed from the network via the communication apparatus 1109, or installed from the storage 1108 or the ROM 1102. When the computer program is executed by the processor 1101, the functions defined in the method of the embodiments of the present disclosure are implemented.

It should be noted that the computer-readable medium described in the present disclosure may be a computer-readable signal medium or a computer-readable storage medium, or any combination of the above two. The computer-readable storage medium may include but is not limited to electrical, magnetic, optical, electromagnetic, infrared, or semiconductor systems, apparatuses, or devices, or a combination of any of the above, for example. More detailed examples of the computer-readable storage medium may include but are not limited to an electrical connection with one or more wires, a portable computer disk, a hard disk, a random-access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer-readable storage medium may be any tangible medium that contains or stores a program. The program may be used by or in conjunction with an instruction execution system, apparatus or device. In the present disclosure, however, the computer-readable signal medium may include a data signal broadcasted in a baseband or as part of a carrier wave with computer-readable program code embodied thereon. Such broadcasted data signal may be in variety of forms, including but not limited to an electromagnetic signal, an optical signal, or any suitable combination of the foregoing. The computer-readable signal medium may be any computer-readable medium other than the computer-readable storage medium. The computer-readable signal medium may send, broadcast, or transmit the program for use by or in connection with the instruction execution system, apparatus, or device. The program code embodied on the computer readable medium may be transmitted by any suitable medium including, but not limited to, an electrical wire, an optical fiber cable, RF (radio frequency), or any suitable combination of the foregoing.

In some implementations, clients and servers may communicate using any currently known or future developed network protocol such as HTTP (HyperText Transfer Protocol), and may interconnect with any form or medium of digital data communication (such as communication networks). Examples of communication networks include a local area network (“LAN”), a wide area network (“WAN”), a internet (such as the Internet), and an end-to-end network (such as ad hoc end-to-end network), as well as any currently known or future developed networks.

The computer readable medium mentioned above may be included in the electronic device mentioned above. It may also exist separately without being assembled into the electronic device.

The computer readable medium mentioned above carries one or more programs, and when one or more programs are executed by the electronic device, the electronic device determines the interface displaying area on the recognized preset human body part, and then generates and displays the operation interface according to the interface displaying area. As a result, the operation interface is displayed on a determined interface displaying area on a human body part, ensuring the user's sense of clicking, improving the user's operating experience, and further enhancing the intelligence degree of the operation interface.

The computer program code for carrying out operations of the present disclosure may be written in one or more programming languages, or a combination thereof. The programming languages include object-oriented programming languages, such as Java, Smalltalk, C++, and conventional procedural programming languages, such as the “C” language or similar programming languages. The program code may be executed entirely on a user computer, partly on a user computer, as a stand-alone software package, partly on a user computer and partly on a remote computer, or entirely on a remote computer or server. In the case of a remote computer, the remote computer may be connected to the user computer through any kind of network, including a local area network (LAN) or a wide area network (WAN). Alternatively, the remote computer may be connected to an external computer (e.g., over the Internet provided by the Internet service provider).

The flowcharts and block diagrams in the drawings illustrate the architecture, functionality, and operation of possible implementations of the system, the method and the computer program product according to various embodiments of the present disclosure. In this regard, each block in the flowcharts or block diagrams may represent a module, a program segment, or a portion of code. The module, program segment, or portion of code contains one or more executable instructions for implementing specified logical functions. It should also be noted that, in some alternative implementations, the functions illustrated in the blocks may be implemented in an order different from the order illustrated in the drawings. For example, two blocks shown in succession may, in fact, be implemented substantially concurrently, or in a reverse order, depending on the functionality involved. It should further be noted that each block in the block diagrams and/or flowcharts and a combination of blocks in the block diagrams and/or flowcharts may be implemented in special purpose hardware-based system that performs the specified functions or operations, or may be implemented in a combination of special purpose hardware and computer instructions.

The units involved in the embodiments of the present disclosure may be implemented by software or hardware. The name of a unit does not, in any case, qualify the unit itself.

The functions described herein above may be executed, at least partially, by one or more hardware logic components. For example, without limitation, available exemplary types of hardware logic components include: a Field Programmable Gate Array (FPGA), an Application Specific Integrated Circuit (ASIC), an Application Specific Standard Product (ASSP), a System on Chip (SOC), a Complex Programmable Logical Device (CPLD), etc.

In the context of the present disclosure, a machine readable medium may be a tangible medium, which may contain or store a program used by the instruction execution system, apparatus, or device or a program used in combination with the instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus or device, or any proper combination thereof. The machine readable storage media, for example, includes an electrical connection based on one or more wires, a portable computer disk, a hard drive, a random access memory (RAM), a read only memory (ROM), an erasable programmable read-only memory (EPROM or flash memory), an optical fiber, a portable compact disk read only memory (CD-ROM), an optical storage device, a magnetic storage device, or any proper combination thereof.

The above description illustrates merely preferred embodiments of the present disclosure and the technical principles employed in the present disclosure. Those skilled in the art should understand that the scope of disclosure involved in the present disclosure should cover other technical solutions formed by any combination of the above technical features or their equivalents without departing from the above disclosed concept, for example, a technical solution formed by replacing the feature with (but not limited to) a technical feature with similar functions disclosed herein, rather than be limited to the technical solutions formed by the specific combination of the technical features.

In addition, although the above operations are described in a specific order, it should not be understood that these operations are required to be performed in the specific order or performed in a sequential order. In some conditions, multitasking and parallel processing may be advantageous. Although multiple implementation details are included in the above descriptions, the details should not be interpreted as limitations to the scope of the present disclosure. Some features described in an embodiment may be implemented in combination in another embodiment. In addition, the features described in an embodiment may be implemented individually or in any suitable sub-combination form in multiple embodiments.

Although the subject of the present disclosure has been described according to the structural features and/or logical actions of the method, it should be understood that the subject defined in the claims is not necessarily limited to the features or actions described above. The specific features and actions described above are only examples of the implementation of the claims.

1. An interface displaying method, comprising:
in response to an interface displaying instruction, recognizing a preset human body part;
determining an interface displaying area on the recognized preset human body part;
generating and displaying an operation interface according to the interface displaying area.

2. The method according to claim 1, wherein before in response to the interface displaying instruction, the method comprises:
detecting a current gesture action of a user;
if the current gesture action is determined to be a preset gesture action, obtaining the interface displaying instruction.

3. The method according to claim 1, wherein the generating and displaying an operation interface according to the interface displaying area comprises:
recognizing area size information of the interface displaying area;
generating and displaying the operation interface according to the area size information.

4. The method according to claim 3, wherein the generating and displaying the operation interface according to the area size information comprises:
determining scaling ratio information according to the area size information;
scaling, according to the scaling ratio information, a preset standard operation interface, to generate and display the operation interface.

5. The method according to claim 1, wherein the determining the interface displaying area on the recognized preset human body part comprises:
recognizing a plurality of human body key points of the preset human body part;
determining the interface displaying area corresponding to the plurality of human body key points.

6. The method according to claim 5, wherein the determining the interface displaying area corresponding to the plurality of human body key points comprises:
determining edge human body key points of the plurality of human body key points;
connecting the edge human body key points to obtain a reference bounding box;
determining the interface displaying area according to the reference bounding box.

7. The method according to claim 6, wherein the determining the interface displaying area according to the reference bounding box comprises:
determining an area surrounded by the reference bounding box to be the interface displaying area; or
determining, in the reference bounding box and according to a preset shape, an area surrounded by a maximum bounding box to be the interface displaying area; or
determining, in the reference bounding box, an area with a preset shape and a preset size to be the interface displaying area.

8. The method according to claim 1, wherein before displaying the operation interface, the method comprises:
determining rendering color information corresponding to the operation interface;
rendering the operation interface according to the rendering color information.

9. The method according to claim 8, wherein the determining rendering color information corresponding to the operation interface comprises:
obtaining reference color information for the interface displaying area;
determining the rendering color information according to the reference color information.

10. The method according to claim 8, wherein the determining rendering color information corresponding to the operation interface comprises:
recognizing current environment information of a displaying device;
determining the rendering color information based on the environment information.

11. The method according to claim 10, wherein the determining the rendering color information based on the environment information comprises:
determining a color information database corresponding to the current space environment information;
obtaining the rendering color information in the color information database.

12. (canceled)

13. An electronic device, comprising:
a processor
a memory for storing executable instructions for the processor;
wherein the processor is configured to read the executable instructions from the memory and execute the executable instructions to implement an interface displaying method, comprising:
in response to an interface displaying instruction, recognizing a preset human body part;
determining an interface displaying area on the recognized preset human body part; and
generating and displaying an operation interface according to the interface displaying area.

14. (canceled)

15. The electronic device according to claim 13, wherein before in response to the interface displaying instruction, the method comprises:
detecting a current gesture action of a user; and
if the current gesture action is determined to be a preset gesture action, obtaining the interface displaying instruction.

16. The electronic device according to claim 13, wherein the generating and displaying an operation interface according to the interface displaying area comprises:
recognizing area size information of the interface displaying area; and
generating and displaying the operation interface according to the area size information.

17. The electronic device according to claim 13, wherein the generating and displaying the operation interface according to the area size information comprises:
determining scaling ratio information according to the area size information; and
scaling, according to the scaling ratio information, a preset standard operation interface, to generate and display the operation interface.

18. The electronic device according to claim 13, wherein the determining the interface displaying area on the recognized preset human body part comprises:
recognizing a plurality of human body key points of the preset human body part; and
determining the interface displaying area corresponding to the plurality of human body key points.

19. The electronic device according to claim 13, wherein before displaying the operation interface, the method comprises:
determining rendering color information corresponding to the operation interface; and
rendering the operation interface according to the rendering color information.

20. The electronic device according to claim 19, wherein the determining rendering color information corresponding to the operation interface comprises:
obtaining reference color information for the interface displaying area; and
determining the rendering color information according to the reference color information.

21. The electronic device according to claim 20, wherein the determining rendering color information corresponding to the operation interface comprises:
recognizing current environment information of a displaying device; and
determining the rendering color information based on the environment information.

22. A non-transitory computer readable storage medium, wherein the computer readable storage medium stores a computer program, and the computer program is configured to perform an interface displaying method, the method comprising:
in response to an interface displaying instruction, recognizing a preset human body part;
determining an interface displaying area on the recognized preset human body part;
generating and displaying an operation interface according to the interface displaying area.
